(19) United States
(12) Patent Application Publication
(10) Pub. No.: US 2021/0354190 A1
(43) Pub. Date: Nov. 18, 2021

(54) Stamping Strip Manufacturing System

(71) Applicants: Tyco Electronics (Shanghai) Co. Ltd., Shanghai (CN); TE Connectivity Services GmbH, Schaffhausen (CH); TE Connectivity Germany GmbH, Bensheim (DE)

(72) Inventors: Yingcong Deng, Shanghai (CN); Dandan Zhang, Shanghai (CN); Lvhai Hu, Shanghai (CN); Fengchun Xie, Shanghai (CN); Roberto Francisco-Yi Lu, Bellevue, WA (US); Josef Sinder, Woert (DE); Zongjie Tao, Shanghai (CN); Xiaochen Yu, Shanghai (CN); Swapnilsinh Solanki, Middletown, PA (US); Jiankun Zhou, Middletown, PA (US); Tim Darr, Middletown, PA (US)

(73) Assignees: Tyco Electronics (Shanghai) Co. Ltd., Shanghai (CN); TE Connectivity Services GmbH, Schaffhausen (CH); TE Connectivity Germany GmbH, Bensheim (DE)

(21) Appl. No.: 17/320,427

(22) Filed: May 14, 2021

(30) Foreign Application Priority Data
May 14, 2020 (CN) 202010408076.3

(51) Int. Cl. B21D 43/28; B21D 43/08; B21D 43/10; B23K 37/04; B21D 43/00; B21D 43/20

(52) U.S. Cl. CPC B21D 43/285; B21D 43/08; B21D 43/10; B23K 2101/36; B21D 43/006; B21D 43/20; B23K 37/04

(57) ABSTRACT

A stamping strip manufacturing system comprises a stamping machine forming terminals in a strip by stamping. A supply reel around which a strip to be stamped is wound supplies the strip to be stamped to the stamping machine, and a recovery reel around which the stamped strip is wound recovers the stamped strip. A strip cutting and welding device of the system cuts off an unqualified strip segment of the strip having an unqualified terminal and welds two cut ends of the cut strip to each other.

### CROSS-REFERENCE TO RELATED APPLICATIONS

This application claims priority under 35 U.S.C. § 119 to Chinese Patent Application No. 202010408076.3 filed on May 14, 2020, the whole disclosure of which is incorporated herein by reference.

### FIELD OF THE INVENTION

The present disclosure relates to a stamping strip manufacturing system, and in particular, to a manufacturing system for stamping a terminal strip.

### BACKGROUND

In order to improve the manufacturing efficiency of terminals, a stamping machine is typically used to continuously stamp terminals in a metal strip. The stamped terminals, together with the strip, are then transported to and wound around a recovery reel. However, due to manufacturing variability, there may be some unqualified terminals produced in the stamped strip during the continuous stamping operation. As a result, a strip segment of the strip having the unqualified terminals needs to be cut off from the strip. However, after the unqualified strip segment is cut off, the amount of the strip wound around each recovery reel will be different, which will adversely affect the subsequent utility of the strip. Therefore, after the strip segment is cut off, it is necessary to weld the two cut ends of the strip to each other. However, in the prior art, the cutting and welding of the strip are manually performed, which is not efficient and adversely affects the utilization rate of the stamping machine.

### SUMMARY

According to an embodiment of the present disclosure, a stamping strip manufacturing system comprises a stamping machine forming terminals in a strip by stamping. A supply reel around which a strip to be stamped is wound supplies the strip to be stamped to the stamping machine, and a recovery reel around which the stamped strip is wound recovers the stamped strip. A strip cutting and welding device of the system cuts off an unqualified strip segment of the strip having an unqualified terminal and welds two cut ends of the cut strip to each other.

### BRIEF DESCRIPTION OF THE DRAWINGS

The invention will now be described by way of example with reference to the accompanying FIGURE, of which:

FIG. 1 is a schematic diagram showing a stamping strip manufacturing system according to an exemplary embodiment of the present disclosure.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to a general technical concept of the present disclosure, a stamping strip manufacturing system is provided, including: a stamping machine adapted to form terminals in a strip by stamping; a supply reel around which a strip to be stamped is wound and which is configured to supply the strip to be stamped to the stamping machine; and a recovery reel around which the stamped strip is wound and which is configured to recover the stamped strip. The stamping strip manufacturing system further includes a strip cutting and welding device configured to cut off an unqualified strip segment of the strip having an unqualified terminal from the strip and weld two cut ends of the cut strip to each other.

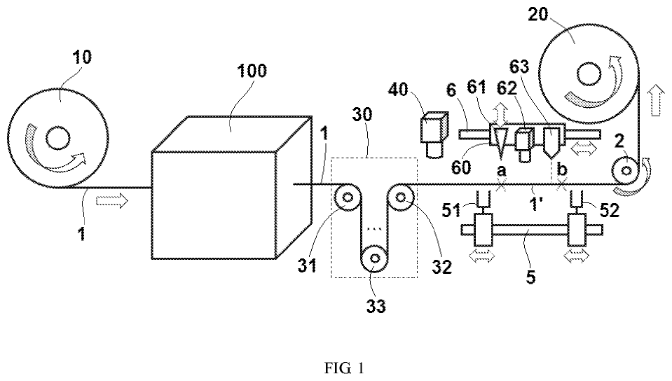

FIG. 1 is a schematic diagram showing a stamping strip manufacturing system according to an exemplary embodiment of the present disclosure.

As shown in FIG. 1, in an embodiment of the present disclosure, the stamping strip manufacturing system includes a stamping machine 100, a supply reel 10 and a recovery reel 20. The stamping machine 100 is adapted to form terminals in the strip 1 by stamping. The strip 1 to be stamped is wound around the supply reel 10 and the supply reel 10 is configured to supply the strip 1 to be stamped to the stamping machine 100. The stamped strip 1 is wound around the recovery reel 20, and the recovery reel 20 is configured to recover the stamped strip 1.

As shown in FIG. 1, in an embodiment of the present disclosure, the stamping strip manufacturing system further includes a strip cutting and welding device 6, 60, 61, 62, 63 configured to cut off an unqualified strip segment 1′ of the strip having an unqualified terminal, and to weld two cut ends a, b of the cut strip 1 to each other.

As shown in FIG. 1, in an embodiment of the present disclosure, the stamping strip manufacturing system further includes a vision inspection device 40 configured to detect whether there is an unqualified terminal in the stamped strip 1 online in real time. The vision inspection device 40 is further configured to determine the unqualified strip segment 1′ to be cut off.

As shown in FIG. 1, in an embodiment of the present disclosure, the vision inspection device 40 is located between the stamping machine 100 and the strip cutting and welding device 6, 60, 61, 62, 63. The strip cutting and welding device 6, 60, 61, 62, 63 is located between the vision inspection device 40 and the recovery reel 20.

As shown in FIG. 1, in an embodiment of the present disclosure, the strip cutting and welding device 6, 60, 61, 62, 63 includes: a cutting device 61 and a welding device 63. The cutting device 61 is configured to cut off the unqualified strip segment 1′ from the stamped strip 1. The welding device 63 is configured to weld the two cut ends a and b of the cut strip 1 to each other.

As shown in FIG. 1, in an embodiment of the present disclosure, the strip cutting and welding device 6, 60, 61, 62, 63 further includes a first slide rail 6 extending in a first direction and a first slider 60 slidably mounted to the first slide rail 6. The cutting device 61 and the welding device 63 are mounted to the first slider 60, and are capable of sliding along the first slide rail 6 together with the first slider 60, so that the cutting device 61 and the welding device 63 are capable of moving to a position where the cut ends a and b of the strip 1 are located.

As shown in FIG. 1, in an embodiment of the present disclosure, the cutting device 61 and the welding device 63 are movably mounted to the first slider 60 so as to be movable in a second direction perpendicular to the first direction.

As shown in FIG. 1, in an embodiment of the present disclosure, the welding device 63 may be a laser welding head. However, the present disclosure is not limited to this, and the welding device 63 may be a welding device of other types, for example, a soldering iron.

As shown in FIG. 1, in an embodiment of the present disclosure, the strip cutting and welding device 6, 60, 61, 62, 63 further includes a vision guiding device 62, which is adapted to guide the cutting device 61 to perform a cutting operation and to guide the welding device 63 to perform a welding operation. In an embodiment of the present disclosure, the vision guiding device 62 is mounted to the first slider 60 and is located between the cutting device 61 and the welding device 63.

As shown in FIG. 1, in an embodiment of the present disclosure, the stamping strip manufacturing system further includes a gripping device 5, 51, 52, which is adapted to grip the strip 1 to ensure that the strip 1 remains stationary when the strip 1 is cut or welded. In an embodiment of the present disclosure, the gripping device 5, 51, 52 includes a second slide rail 5 extending in the first direction, and a first gripper 51 and a second gripper 52 which are slidably mounted to the second slide rail 5. The first gripper 51 is configured to grip the strip 1 near one cut end a of the two cut ends a, b of the strip 1, and the second gripper 52 is configured to grip the strip 1 near the other cut end b of the two cut ends a, b of the strip 1.

As shown in FIG. 1, in an embodiment of the present disclosure, when the vision inspection device 40 detects an unqualified strip segment 1′, the recovery reel 20 stops immediately, and the first gripper 51 and the second gripper 52 grip the strip 1. The cutting device 61 cuts off the unqualified strip segment 1′ after the strip 1 is gripped by the first gripper 51 and the second gripper 52.

As shown in FIG. 1, in an embodiment of the present disclosure, after the unqualified strip segment 1′ is cut off, the first gripper 51 and the second gripper 52 are moved towards each other, such that the two cut ends a and b of the strip 1 are aligned and brought into contact with each other. The welding device 63 welds the two cut ends a, b of the strip 1 to each other after the two cut ends a, b of the strip 1 are aligned and brought into contact with each other.

As shown in FIG. 1, in an embodiment of the present disclosure, the stamping strip manufacturing system further includes a strip buffering device 30 located between the vision inspection device 40 and the stamping machine 100. The strip buffering device 30 is adapted to store a predetermined length of a segment of the strip 1, so as to store the strip 1 output from the stamping machine 100 when the strip 1 is gripped by the gripping device 5, 51, 52, ensuring that the stamping machine 100 does not stop when the strip 1 is gripped by the gripping device 5, 51, 52.

As shown in FIG. 1, in an embodiment of the present disclosure, the strip buffering device 30 includes a pair of fixed rollers 31 and 32, and a movable roller 33 located between the pair of fixed rollers 31 and 32. The strip 1 is supported on the pair of fixed rollers 31 and 32, and the movable roller 33 is hung on the strip 1 to drive the strip 1 to move downwards, so that the predetermined length of the segment of the strip 1 can be stored.

As shown in FIG. 1, in an embodiment of the present disclosure, the stamping strip manufacturing system further includes a deflecting roller 2 located between the strip cutting and welding device 6, 60, 61, 62, 63 and the recovery reel 20. The deflecting roller 2 is configured to deflect a conveying direction of the strip 1 from the first direction to the second direction perpendicular to the first direction, so as to reduce the length of the entire production line of the stamping strip manufacturing system in the first direction.

The production process of the stamping strip will be described below with reference to FIG. 1.

The supply reel 10 continuously supplies the strip 1 to be stamped to the stamping machine 100 which continuously stamps the strip 1 to form terminals in the strip 1. The strip 1 then passes through the strip buffering device 30 after which the vision inspection device 40 inspects the stamped strip 1 to detect whether there is an unqualified strip segment 1′ in the stamped strip 1. If the vision inspection device 40 detects the unqualified strip segment 1′, the recovery reel 20 stops immediately, but the stamping machine 100 continues to operate, while the first gripper 51 and the second gripper 52 grip the two cut ends a and b of the strip 1, and the stamped strip 1 is stored in the strip buffering device 30. Subsequently, the cutting device 61 cuts off the unqualified strip segment 1′ under the guidance of the vision guiding device 62. Once cut, the first gripper 51 and the second gripper 52 are moved towards each other, so that the two cut ends a and b of the strip 1 are aligned and brought into contact with each other. The welding device 63 welds the two cut ends a and b of the strip 1 to each other under the guidance of the vision guiding device 62, after which the first gripper 51 and the second gripper 52 are released to release the strip 1, and the recovery reel 20 is restarted to recover the strip 1.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A stamping strip manufacturing system, comprising:
a stamping machine for forming terminals in a strip by stamping;
a supply reel around which a strip to be stamped is wound for supplying the strip to be stamped to the stamping machine;
a recovery reel around which the stamped strip is wound for recovering the stamped strip; and
a strip cutting and welding device for cutting off an unqualified strip segment of the strip having an unqualified terminal from the strip and welding two cut ends of the cut strip to each other.

2. The stamping strip manufacturing system according to claim 1, further comprising a vision inspection device for detecting an unqualified terminal in the stamped strip and determining the unqualified strip segment to be cut off.

3. The stamping strip manufacturing system according to claim 2, wherein the vision inspection device is positioned between the stamping machine and the strip cutting and welding device, and the strip cutting and welding device is positioned between the vision inspection device and the recovery reel.

4. The stamping strip manufacturing system according to claim 2, wherein the strip cutting and welding device includes a cutting device for cutting off the unqualified strip segment from the stamped strip, and a welding device for welding the two cut ends of the cut strip to each other.

5. The stamping strip manufacturing system according to claim 4, wherein the strip cutting and welding device further comprises:
a first slide rail extending in a first direction; and
a first slider slidably mounted to the first slide rail, the cutting device and the welding device are mounted to the first slider for sliding along the first slide rail with the first slider such that the cutting device and the welding device are moveable to a position where the cut ends of the strip are located.

6. The stamping strip manufacturing system according to claim 5, wherein the cutting device and the welding device are movably mounted to the first slider so as to be movable in a second direction perpendicular to the first direction.

7. The stamping strip manufacturing system according to claim 6, wherein the strip cutting and welding device further includes a vision guiding device guiding the cutting device to perform a cutting operation and guiding the welding device to perform a welding operation.

8. The stamping strip manufacturing system according to claim 7, wherein the vision guiding device is mounted to the first slider and is positioned between the cutting device and the welding device.

9. The stamping strip manufacturing system according to claim 8, further comprising a gripping device for gripping the strip to ensure that the strip remains stationary when the strip is cut or welded.

10. The stamping strip manufacturing system according to claim 9, wherein the gripping device comprises:
a second slide rail extending in the first direction;
a first gripper for gripping the strip near one cut end of the two cut ends of the strip; and
a second gripper for gripping the strip near the other cut end of the two cut ends of the strip, the first and second grippers slidably mounted to the second slide rail.

11. The stamping strip manufacturing system according to claim 10, wherein, when the vision inspection device detects an unqualified strip segment:
the recovery reel stops;
the first gripper and the second gripper grip the strip; and
the cutting device cuts off the unqualified strip segment after the strip is gripped by the first gripper and the second gripper.

12. The stamping strip manufacturing system according to claim 11, wherein, after the unqualified strip segment is cut off, the first gripper and the second gripper are moved towards each other for aligning and bringing into contact the two cut ends of the strip, the welding device welding the two cut ends of the strip to each other after the two cut ends of the strip are aligned and brought into contact with each other.

13. The stamping strip manufacturing system according to claim 9, further comprising a strip buffering device positioned between the vision inspection device and the stamping machine, the strip buffering device selectively storing a predetermined length of a segment of the strip output from the stamping machine when the strip is gripped by the gripping device.

14. The stamping strip manufacturing system according to claim 13, wherein the strip buffering device comprises:
a pair of fixed rollers; and
a movable roller located between the pair of fixed rollers, the strip supported on the pair of fixed rollers, and the movable roller hung on the strip to drive the strip to move downwards for storing the predetermined length of the segment.

15. The stamping strip manufacturing system according to claim 1, further comprising a deflecting roller positioned between the strip cutting and welding device and the recovery reel, the deflecting roller deflecting a conveying direction of the strip from a first direction to a second direction perpendicular to the first direction for reducing a length of the stamping strip manufacturing system in the first direction.

16. A stamping strip manufacturing system, comprising:
a stamping machine for forming terminals in a strip;
a strip cutting and welding device for cutting off an unqualified strip segment of the strip having an unqualified terminal from the strip and welding two cut ends of the cut strip to each other;
a vision inspection device for detecting an unqualified terminal in the stamped strip online in real time and determining the unqualified strip segment to be cut off; and
a gripping device for gripping the strip to ensure that the strip remains stationary when the strip is cut or welded.

17. The stamping strip manufacturing system according to claim 16, wherein the strip cutting and welding device further comprises:
a first slide rail extending in a first direction; and
a first slider slidably mounted to the first slide rail, a cutting device and a welding device of the strip cutting and welding device are mounted to the first slider and are moveable along the first slide rail with the first slider and movable in a second direction perpendicular to the first direction.

18. The stamping strip manufacturing system according to claim 17, wherein the gripping device comprises:
a second slide rail extending in the first direction;
a first gripper for gripping the strip near one cut end of the two cut ends of the strip; and
a second gripper for gripping the strip near the other cut end of the two cut ends of the strip, the first and second grippers slidably mounted to the second slide rail.

19. The stamping strip manufacturing system according to claim 16, further comprising a strip buffering device positioned between the vision inspection device and the stamping machine, the strip buffering device selectively storing a predetermined length of a segment of the strip output from the stamping machine when the strip is gripped by the gripping device.

20. The stamping strip manufacturing system according to claim 19, wherein the strip buffering device comprises:
a pair of fixed rollers; and
a movable roller located between the pair of fixed rollers, the strip supported on the pair of fixed rollers, and the movable roller hung on the strip to drive the strip to move downwards, such that the predetermined length of the segment of the strip is stored.
